(19) United States
(12) Patent Application Publication
(10) Pub. No.: US 2025/0105314 A1
(43) Pub. Date: Mar. 27, 2025

(54) FIN STRUCTURE, RADIATOR, AND FUEL CELL COOLING SYSTEM

(71) Applicant: Caterpillar Inc., Peoria, IL (US)

(72) Inventors: Lei YU, Wuxi (CN); Gengxin Liu, Wuxi (CN); Guoping Tian, Wuxi (CN); Guanqing Guo, Wuxi (CN); Yuerou Wang, Wuxi (CN)

(73) Assignee: Caterpillar Inc., Peoria, IL (US)

(21) Appl. No.: 18/891,873

(22) Filed: Sep. 20, 2024

(30) Foreign Application Priority Data
Sep. 21, 2023 (CN) 202311221817.7

(51) Int. Cl. H01M 8/04014; F28F 3/02; H01M 8/04029

(52) U.S. Cl. CPC H01M 8/04014; F28F 3/025; H01M 8/04029

(57) ABSTRACT

The present disclosure relates to a fin structure for a radiator, comprising a plurality of elongated fins arranged in parallel and spaced apart from each other, wherein an air flow channel is defined between opposing main side surfaces of adjacent two fins for allowing cooling air to flow therethrough along a fin longitudinal direction; a corrugated section extending in the fin longitudinal direction is formed on each fin; and the fins are arranged such that for adjacent fins, the peaks of the corrugated sections are aligned in the arranging direction of the fins and troughs of the corrugated sections are aligned in the arranging direction of the fins, characterized in that, in each wavy unit of the corrugated section, the wave peak is offset from a central plane between two adjacent wave troughs and approaches an inclined slope extending between a wave peak and a wave trough in an adjacent wavy unit of a corrugated section of an adjacent fin. The present disclosure also relates to a radiator with said fin structure, as well as a fuel cell cooling system comprising such a radiator.

### TECHNICAL FIELD

The present disclosure relates to a technical field of a fuel cell cooling system, in particular a fin structure for a radiator, a radiator with such a fin structure, and a fuel cell cooling system comprising the radiator.

### BACKGROUND

In a fuel cell cooling system, cooling liquid flows via cooling liquid passages between anode and cathode plates of a fuel cell stack. With forced convection heat-exchanging of the cooling liquid, heat produced during a working process of fuel cells is removed. The cooling liquid may be deionized water or a mixture of water and ethylene glycol. The cooling liquid thus heated dissipates heat in a radiator, which reduces temperature of the cooling liquid. The cooling liquid thus cooled is then delivered to the fuel cell stack for continuously cooling the fuel cell stack.

With respect to the design of the radiator of the fuel cell cooling system, it faces greater challenges than a conventional cooling water system for a diesel system, which are reflected mainly in the following two points: 1) the required heat-exchanging amount has increased. Heat-exchanging amount by the water tank of traditional diesel systems accounts for approximately 33% of the engine's power, while the required heat-exchanging amount by the radiator of the fuel cell cooling system is up to two to three times higher than the amount obtained by the water tank; 2) The temperature difference for heat-exchanging with ambient air has decreased. The temperature difference for heat-exchanging between the water temperature in the water tank of a traditional fuel-powered vehicle and the ambient air temperature is around 55° C. However, due to the relatively low operating temperature of the fuel cells, the temperature difference for heat-exchanging between the cooling water temperature in the radiator of the fuel cell system and the ambient air temperature is around 28° C. With the traditional radiator layout and fin form, a larger radiator and a larger space will be required to meet the heat-exchanging requirement of the fuel cells. This will further increase the difficulty in internal space design of the fuel cell vehicles, meaning that the fuel cell vehicles will be bulky and costly.

Accordingly, it is the object of the present disclosure to solve one or more of the above problems.

### SUMMARY OF THE DISCLOSURE

To solve the cooling problem of fuel cells, the present disclosure provides an improved fin structure for a radiator of a fuel cell cooling system, which can increase heat-exchanging capacity of the radiator to meet the heat-exchanging requirement and reduce the size of the radiator and the fuel cell cooling system (size of a water tank and a fan), and to lower the system cost.

According to one aspect of the present disclosure, a fin structure for the radiator is provided, comprising a plurality of elongated corrugated fins spaced from each other and arranged in parallel. An air flow channel is defined between opposing main side surfaces of adjacent two fins for allowing cooling air to flow therethrough along the fin longitudinal direction. A corrugated section extending in the fin longitudinal direction is formed on each fin. The fins are arranged such that for adjacent fins, the peaks of the corrugated sections are aligned in the arranging direction of the fins and troughs of the corrugated sections are aligned in the arranging direction of the fins. It is characterized in that, in each wavy unit of the corrugated section, the wave peak is offset from a central plane between two adjacent wave troughs and approaches an inclined slope extending between a wave peak and a wave trough in an adjacent wavy unit of a corrugated section of an adjacent fin.

Preferably, with respect to an air flow direction in the air flow channel, the inclined slopes of each wavy unit of the corrugated section comprise an uphill inclined slope and a downhill inclined slope, and an uphill inclination angle of the uphill inclined slope relative to the fin longitudinal direction is greater than a downhill inclination angle of the downhill inclined slope relative to the fin longitudinal direction.

Preferably, the wavy units of the corrugated section of each fin have the same waveform cross-section.

Preferably, for each fin, the corrugated section is formed over an entire length of the fin.

Preferably, the fin structure is formed as a one-piece part, comprising said fins and connecting base portions located on edge sides of the fins.

Preferably, the one-piece part extends in a pulse waveform in the arranging direction of the fins, wherein adjacent edge sides of the fins are connected via the connecting base portions at wave peaks and wave troughs of the pulse waveform.

The fin structure according to the present disclosure utilizes the disturbance of air flow caused by the undulating contour within the air flow channel to induce turbulence, thereby improving heat transfer efficiency, reducing the size of the cooling system (size of a water tank and a fan), lowering costs and solving the problem of a bulky and costly cooling water system in existing fuel cell vehicles.

According to another aspect of the present disclosure, a radiator for a fuel cell cooling system is provided, which comprises a radiator core comprising: a plurality of substantially flat fluid plates spaced apart and arranged in parallel along a thickness direction of the radiator core, with a plurality of fluid channels being defined in each fluid plate for fluid to be cooled to flow therethrough; and fin group(s) arranged between adjacent fluid plates, wherein the fin group(s) has the aforementioned fin structure.

Preferably, the fluid channels extend in a lengthwise direction of the radiator core, and the air flow channels are arranged side by side in the lengthwise direction of the radiator core.

According to another aspect of the present disclosure, a fuel cell cooling system is provided, which comprises a fuel cell and a radiator configured to cool the fuel cell, wherein the fuel cell and the radiator are fluidly connected to form a cooling circuit where cooling liquid circulates, characterized in that the radiator is the aforementioned radiator, and the cooling liquid flows, as fluid to be cooled, into fluid channels defined in fluid plates of the radiator core.

The fuel cell cooling system according to the present disclosure effectively utilizes a radiator with improved heat transfer efficiency and a sufficiently small size, reducing the size of the entire fuel cell cooling system (the size of cooling unit, water tank and fan) and lowering system costs.

### BRIEF DESCRIPTION OF THE DRAWINGS

The drawings described herein are provided for further understanding features and advantages of an example of the present disclosure:

FIG. 1 is a perspective schematic diagram of a radiator according to the present disclosure;

FIG. 2 is a perspective schematic diagram of a heat dissipation unit of a radiator core of the radiator according to the present disclosure;

FIG. 3 is a perspective schematic diagram of a portion of the heat dissipation unit in FIG. 2 after removing a fluid plate on one side;

FIG. 4 is a schematic diagram of some segments of a fin structure according to the present disclosure;

FIG. 5 is a flow pattern schematic diagram for an air flow channel of the fin structure according to the first embodiment of the present disclosure;

FIG. 6 is a flow pattern schematic diagram in the air flow channel of the fin structure according to the second embodiment of the present disclosure; and

FIG. 7 is a schematic diagram of a fuel cell cooling system according to the present disclosure.

### DETAILED DESCRIPTION

The following will specifically refer to various embodiments of the present disclosure, examples of which are shown in the drawings. The same reference numerals are used in all drawings to represent the same or similar components.

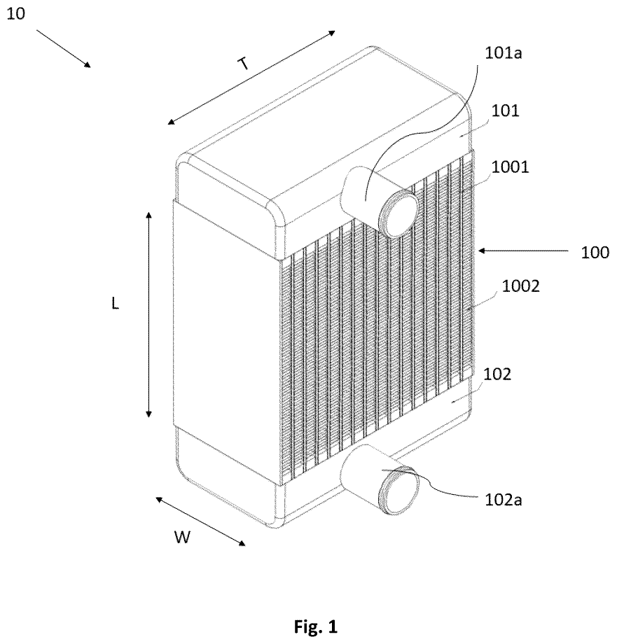

Referring to FIG. 1, a radiator 10 for a fuel cell cooling system according to the present disclosure comprises a radiator core 100 and a flow-division chamber 101 and a flow-collecting chamber 102 located on both ends of the radiator core. An inlet pipe 101a is fluidly connected to the flow-division chamber 101 to allow the fluid to be cooled to enter the flow-division chamber. The fluid discharged from the radiator core enters the flow-collecting chamber 102 and flows out through an outlet pipe 102a. The radiator core 100 comprises a plurality of substantially flat fluid plates (with channels provided therein) 1001 that are spaced apart and arranged in parallel along a thickness direction T of the radiator core, and fin groups 1002 disposed between adjacent fluid plates. Adjacent fluid plates and the fin group disposed therebetween constitute a basic heat dissipation unit.

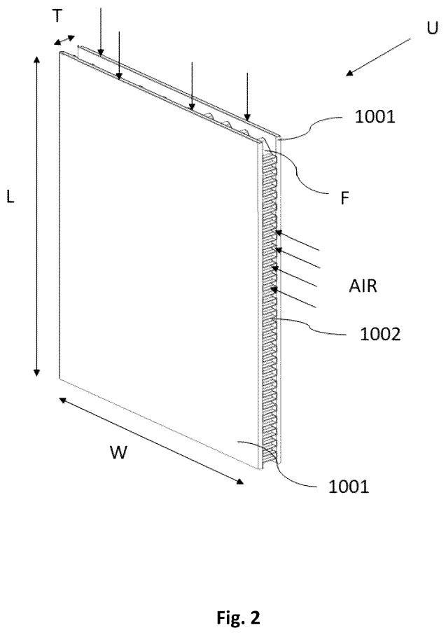

FIG. 2 shows a heat dissipation unit U of the radiator core 100 of the radiator according to the present disclosure. In the embodiment of the heat dissipation unit shown, a plurality of fluid channels are defined in each fluid plate 1001, extending along a lengthwise direction L of the radiator core. In the example shown, the fluid to be cooled (cooling liquid for the fuel cell cooling system) enters the fluid channels from inlets located on the upper side and exits through outlets located on the lower side. The fin group 1002 comprises a plurality of elongated corrugated fins F extending along a widthwise direction W of the radiator core. The fins are spaced apart and arranged in parallel in the lengthwise direction of the heat dissipation unit, thereby defining air flow channels between the opposing main sides of adjacent fins F for cooling air AIR to flow therethrough. The air flow channels generally extend along the widthwise direction of the heat dissipation unit (i.e., parallel to the fin longitudinal direction) and are arranged in parallel in the lengthwise direction of the heat dissipation unit. The cooling air AIR enters the air flow channels through inlets located at one end in the widthwise direction of the heat dissipation unit, of the air flow channels, and exchanges heat with the fluid to be cooled in the fluid channels of the fluid plates, when flowing through the air flow channels, thereby lowering the temperature of the fluid to be cooled. The air thus heated exits through outlets located at the other end in the widthwise direction, of the air flow channels.

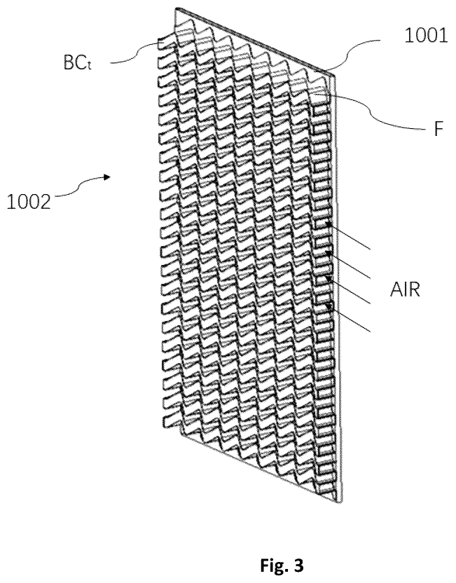

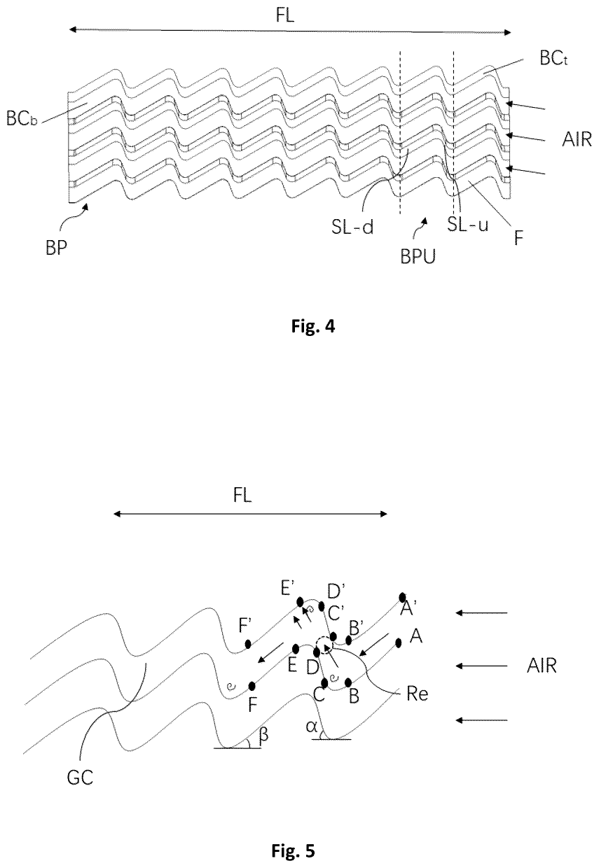

FIG. 3 is a three-dimensional schematic diagram of the fin group 1002 disposed between the fluid plates. FIG. 4 is a side view of a section taken along the lengthwise direction of the radiator core, of the fin group as shown in FIG. 3. FIG. 5 is a schematic diagram of the waveform cross-section of the corrugated sections of fins. According to the present disclosure, the fin group in each heat dissipation unit has a fin structure where each fin is provided with a corrugated section BP extending in the fin longitudinal direction over its entire length, and a plurality of fins are arranged such that, for adjacent fins, the peaks of the corrugated sections are aligned in the arranging direction of the fins and troughs of the corrugated sections are aligned in the arranging direction of the fins. In each wavy unit BPU of the corrugated section, the peak is offset from the central plane between two adjacent troughs and gets close to or approaches an inclined slope extending between a peak and a trough of an adjacent wavy unit in a corrugated section of an adjacent fin.

In the specific embodiment shown, with respect to the air flow direction in the air flow channel, each wavy unit BPU of the corrugated section has an uphill inclined slope SL-u and a downhill inclined slope SL-d. An uphill inclination angle α of the uphill inclined slope relative to the fin longitudinal direction FL is greater than a downhill inclination angle β of the downhill inclined slope relative to the fin longitudinal direction. For example, the uphill inclination angle is approximately 60 degrees, and the downhill inclination angle is approximately 30 degrees. Preferably, the wavy units of the corrugated sections of all fins have the same waveform cross-section. That is, characteristic parameters such as the connecting fillet at the peak, the connecting fillet at the trough, wave pitch, wave amplitude, uphill or downhill inclined slopes, etc., are all the same.

Referring to FIG. 5, air entering the air flow channels inevitably undergoes motion similar to going uphill or downhill when flowing. Taking a downhill-uphill-downhill motion process of air flow in the air flow channel GC as an example, the changes in air flow pattern are explained as follows:

Limited by downhill sections AB and A′B′, the air flow flows along the inclined downhill passage to the trough region, where the air flow impacts the bottom wall, forming a vortex, and then rushes up the uphill passage defined by uphill sections CD and C′D′. Since the uphill inclination angle of each wavy unit is greater than the downhill inclination angle, the uphill passage is shorter than the downhill passage. With the help of the impact force of the vortex, the air flow can easily climb up the uphill passage. Additionally, halfway through the uphill passage, due to the offset of the wave peak towards the inclined slope (uphill section), a cross-section reducing part Re is formed in the corresponding area of the uphill passage. When passing through the cross-section reducing part Re, the air flow accelerates due to the throttling effect. The accelerated air flow directly impinges on the downstream top wall of the wave peak and rushes into the downhill passage defined by downhill sections EF and E′F′. At the wave peak, the air flow impinges on the top wall, forming a vortex, and due to flow inertia, it rushes directly against the inner wall of the downhill section E′F′, avoiding the formation of any laminar flow at the wave peak. Following the downhill passage, which is longer than the uphill passage, the air flow straightens its flow along the way and rushes to the wave trough, forming a vortex. Then, the air flow flows to the next uphill passage with the help of momentum of the vortex flow. In this way, the air flow periodically travels downhill-uphill-downhill throughout the air flow channel, switching between the diffusion-contraction-diffusion movement modes, until it is discharged from the air flow channel.

During the entire flow process, the air flow basically moves in a turbulent flow state, with constantly changing velocities and intense collisions in various directions. This reduces laminar flow or flow dead zones, disrupts the laminar flow boundary layer, and enhances convective heat transfer. Therefore, the heat transfer efficiency is significantly improved.

Therefore, the fin structure shown in the embodiment of the present disclosure can greatly increase the heat-exchanging efficiency of the fins and thus enable designing a radiator as small as possible.

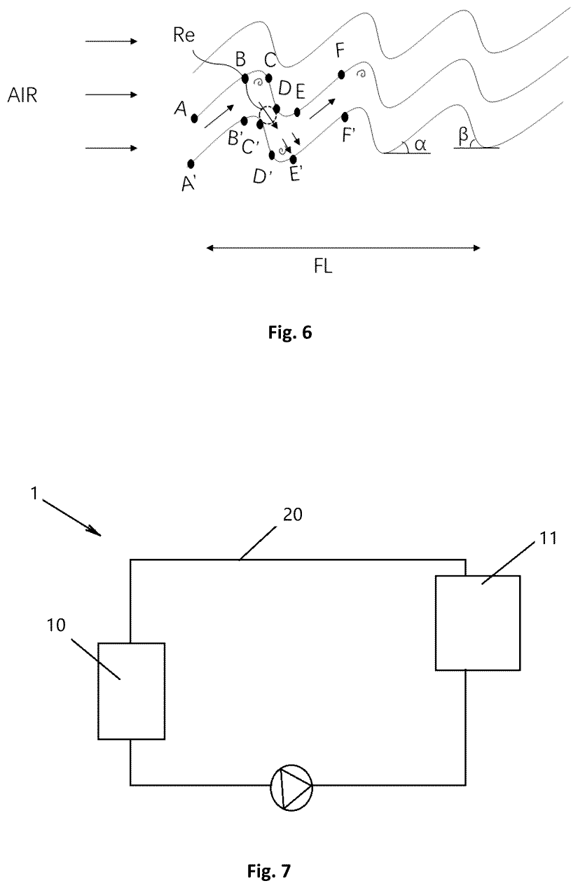

Although the embodiment shown in the figure depicts an uphill inclination angle greater than the downhill inclination angle, it can be understood that the uphill inclination angle α can be set to be less than the downhill inclination angle β, which can also ensure a significant improvement in heat-exchanging efficiency compared to traditional fins in sinusoidal waveform. As shown in FIG. 6, an air flow with a certain velocity flows to the wave peak region through the uphill passage defined by the uphill sections AB and A′B′, forming a vortex, and simultaneously flows down to the downhill passage defined by the downhill sections CD and C′D′. After passing through the cross-section reducing part Re, it accelerates and rushes to the bottom wall of the wave trough region, forming a vortex. Then, it rushes up the uphill passage defined by the uphill sections EF and E′F′ with the help of momentum of the vortex flow. Such periodic switching between diffusion-contraction-diffusion movement modes can also enhance turbulence to a certain extent and disrupt the laminar flow boundary layer, thereby improving heat transfer efficiency.

To further improve heat transfer efficiency, for each fin in the fin group, the corrugated section is formed over the entire length of the fin.

Looking back at FIGS. 3 and 4, the fin group according to the present disclosure is preferably formed as a one-piece part, with the fins F being held in shape through connecting base portions BCt and BCb located on the edge sides of fins and positioned between the fluid plates. In the shown exemplary embodiment, the one-piece fin group extends in a pulse waveform along the lengthwise direction of the radiator core, i.e., the adjacent edge sides of the fins are connected through the connecting base portions BCt at the peaks of the pulse waveform and the connecting base portions BCb at the troughs of the pulse waveform. The connecting base portions are fixedly connected to the adjacent fluid plates through welding. The connecting base portions are preferably flat connection parts, thereby providing a large welding area for welding between the fin group and the fluid plates. Therefore, for the fin structure according to the present disclosure, it is easy to make by stamping from a sheet metal and easy to attach onto the fluid plates by brazing.

Although the radiator shown in FIG. 1 is a plate fin heat exchanger, it can be designed as a tube-and-fin heat exchanger.

According to the present disclosure, a highly efficient fuel cell cooling system 1 can be obtained with the help of a radiator that greatly improves heat-exchanging efficiency within a certain volume. As shown in FIG. 7, the fuel cell cooling system 1 includes a fuel cell 11 and the aforementioned radiator 10 for cooling the fuel cell. As depicted in FIG. 7, the fuel cell cooling system 1 comprises a cooling circuit 20 in which cooling liquid circulates, with the fuel cell 11 and radiator 10 being arranged in this cooling circuit. The cooling liquid in the cooling circuit, after carrying away heat from the fuel cell, flows into the fluid channels defined within the fluid plates of the radiator core, exchanges heat with the air, cools down, and finally flows out of the radiator. Under the action of a pump, the cooling liquid re-enters the fuel cell. This cycle repeats continuously.

### INDUSTRIAL APPLICABILITY

To facilitate understanding of the present disclosure, the following provides an explanation of the assembling method and working principle of the radiator according to the present disclosure:

As shown in FIG. 1, a plurality of fluid plates 1001 are provided, which are arranged in an upright state and spaced along the thickness direction of the radiator core. Between each two adjacent fluid plates, a fin group 1002 is arranged in the following manner: elongated corrugated fins F of the same configuration are arranged at a certain interval in the vertical direction (the lengthwise direction of the radiator core), such that the fin longitudinal direction FL of the fins F is substantially consistent with the widthwise direction of the radiator core, and the peak of each wave unit in the corrugated section is offset from the center plane between adjacent two wave troughs and biased against the air flow direction. After all the fin groups 1002 are pre-assembled between the adjacent fluid plates or between the fluid plates and side plates, with the connecting base portions of the fin groups abutting against the sides of the fluid plates, all the parts in the whole assembly are fixed by brazing or other methods, thus obtaining the radiator core 100. A flow-division chamber 101 is installed at the upper end of the radiator core, and a flow-collecting chamber 102 is installed at the lower end of the radiator core, enabling cooling liquid to flow into and out of the radiator core in a predetermined manner.

In this way, the well-assembled radiator 10 operates in a predetermined manner: cooling liquid flows into the fluid channels of the fluid plates of the radiator core, exchanges heat with the air flowing into each air flow channel, and then the cooling liquid cooled is discharged from the radiator, while the air heated is expelled into the external environment. The cooled cooling liquid exiting the radiator then enters the fuel cell for cooling the fuel cell, and the cooling liquid carrying the heat generated by the fuel cell reaction and leaving the fuel cell then enters the radiator for being cooled.

The radiator according to the present disclosure enables improved heat-exchanging performance without changing the size of the housing (i.e., the size of the radiator and the fan), thereby greatly reducing the manufacturing cost of the fuel cell cooling system. In addition, due to the design and use of efficient fins, the length of the air flow channels can be reduced, achieving a favorable balance between increasing of heat-exchanging capacity and increasing of flow resistance. Furthermore, the widthwise direction size of the heat dissipation unit of the present disclosure can be designed to be smaller, therefore allowing more flexible arrangements. By application of the aforementioned efficient fins, the radiator of the present disclosure exhibits far superior heat-exchanging performance compared to existing radiators, without increasing the overall volume.

The above description merely illustrates exemplary embodiments of the radiator and the fuel cell cooling system according to the present disclosure. The structure/configuration of the radiator is not limited to the specific embodiments described here. Instead, each component can be used independently and separately relative to other components described here. The mentions of “one example,” “another example,” “example,” etc., throughout the specification refer to the inclusion of a certain element/component (such as a feature, structure, and/or characteristic) related to the example in at least one example described here, which may or may not be present in other examples. Furthermore, it is understood that a plurality of elements of any example can be combined in any suitable manner in a plurality of different examples, unless explicitly stated in the context.

This specification uses examples to disclose the invention, including the best embodiments, and enables any person skilled in the art to implement the invention. The scope of patent protection for the invention is defined by the claims and may include other examples that a person skilled in the art would think of. If these other examples have structural elements that do not differ from the literal language of the claims, or if these other examples include equivalent structural elements which do not constitute a substantive difference from the literal language of the claims, these other examples should fall within the scope of the claims.

What is claimed is:

1. A fin structure for a radiator, comprising a plurality of elongated fins arranged in parallel and spaced apart from each other, wherein an air flow channel is defined between opposing main side surfaces of adjacent two fins for allowing cooling air to flow therethrough along a fin longitudinal direction; a corrugated section extending in the fin longitudinal direction is formed on each fin; and the fins are arranged such that for adjacent fins, the peaks of the corrugated sections are aligned in the arranging direction of the fins and troughs of the corrugated sections are aligned in the arranging direction of the fins, characterized in that, in each wavy unit of the corrugated section, the wave peak is offset from a central plane between two adjacent wave troughs and approaches an inclined slope extending between a wave peak and a wave trough in an adjacent wavy unit of a corrugated section of an adjacent fin.

2. The fin structure according to claim 1, characterized in that with respect to an air flow direction in the air flow channel, the inclined slopes of each wavy unit of the corrugated section comprise an uphill inclined slope and a downhill inclined slope, and an uphill inclination angle of the uphill inclined slope relative to the fin longitudinal direction is greater than a downhill inclination angle of the downhill inclined slope relative to the fin longitudinal direction.

3. The fin structure according to claim 1 or 2, characterized in that the wavy units of the corrugated section of each fin have a same waveform cross-section.

4. The fin structure according to any one of claims 1 to 3, characterized in that for each fin, the corrugated section is formed over an entire length of the fin.

5. The fin structure according to any one of claims 1 to 4, characterized in that the fin structure is formed as a one-piece part, comprising the fins and connecting base portions located on edge sides of the fins.

6. The fin structure according to claim 5, characterized in that the one-piece part extends in a pulse waveform in the arranging direction of the fins, wherein adjacent edge sides of the fins are connected via the connecting base portions at wave peaks and wave troughs of the pulse waveform.

7. A radiator for a fuel cell cooling system, comprising a radiator core which comprises a plurality of substantially flat fluid plates spaced apart and arranged in parallel along a thickness direction of the radiator core, with a plurality of fluid channels being defined in each fluid plate for fluid to be cooled to flow therethrough; and fin group(s) arranged between adjacent fluid plates, wherein the fin group(s) has the fin structure according to any one of claims 1 to 6.

8. The radiator according to claim 7, wherein the fluid channels extend in a lengthwise direction of the radiator core, and the air flow channels are arranged side by side in the lengthwise direction of the radiator core.

9. A fuel cell cooling system, comprising a fuel cell and a radiator configured to cool the fuel cell, wherein the fuel cell and the radiator are fluidly connected to form a cooling circuit where cooling liquid circulates, characterized in that the radiator is a radiator according to claim 7 or 8, and the cooling liquid flows, as fluid to be cooled, into fluid channels defined in fluid plates of the radiator core.
